(19) United States
(12) Patent Application Publication
(10) Pub. No.: US 2007/0157129 A1
(43) Pub. Date: Jul. 5, 2007

(54) System and method for search queries and results preview using drag and drop interface

(75) Inventors: Michael Facemire, Cary, NC (US); Eric Leonard Masselle, Raleigh, NC (US); Patick Gabriel McGowan, Chapel Hill, NC (US); Michael C. Wanderski, Durham, NC (US)

Correspondence Address: IBM CORPORATION - RSW (JVL);C/O VAN LEEUWEN & VAN LEEUWEN, P.O. BOX 90609, AUSTIN, TX, 78709-0609, US

(73) Assignee: International Business Machines Corporation

(21) Appl. No.: 11/325,904

(22) Filed: Jan. 5, 2006

(51) Int. Cl. G06F 7/00; G06F 17/30

(52) U.S. Cl. 715/968; 707/3

(57) ABSTRACT

A system and method that that interactively provides search previews to users from one or more data sources is provided. In addition, the user interactively combines searches using a drag and drop interface and receive previews of the combined searches. A palate of graphical objects (icons) are displayed to the user. Each of the graphical objects corresponds to a different database search. The user selects one or more of the graphical objects and drags them to a data source representation, such as a data source window. In response to the user's action, a preview request is created and sent to the data source. The user's computer then receives the preview results from the data source and the preview results are displayed to the user.

### BACKGROUND OF THE INVENTION

1. Technical Field

The present invention relates in general to a system and method for previewing a database search. More particularly, the present invention relates to a system and method that uses a drag and drop interface to return database search previews prior to searching an entire database.

2. Description of the Related Art

Modern computing environments provide many places where data can be stored. Data sources can be a client's local computer system, servers, or other computers, on a network, as well as remote systems accessed through a computer network, such as the Internet. While accessing information from a select number of data sources reduces the number of places information is stored, a challenge is that, without proper organization, users can quickly suffer from information overload. When information is not properly organized, users rely on broad sweeping searches of various data sources. Running full searches against various data sources can be time consuming as well as potentially confusing. Furthermore, needlessly running full searches can burden servers and other data source providers.

What is needed, therefore, is a system and method that provides an interactive way of seeking information by returning a preview of a search. What is further needed is a system and method that allows the user to interactively and easily combine searches as well as easily direct searches to various data sources.

### SUMMARY

It has been discovered that the aforementioned challenges are resolved using a system and method that interactively provides search previews to users from one or more data sources. In addition, the user can interactively combine searches using a drag and drop interface and receive previews of the combined searches. When a preview search displays information that the user finds helpful, the user has the option of requesting a full search from the data source.

A palate of graphical objects (icons) are displayed to the user. Each of the graphical objects corresponds to a different database search. The user selects one or more of the graphical objects and drags them to a data source representation, such as a data source window. In response to the user's action, a preview request is created and sent to the data source. The user's computer then receives the preview results from the data source and the preview results are displayed to the user.

In one embodiment, the data source maintains a cache that is separate from the database. When a preview request is received, the cache is used to process the request rather than burdening the full database with the request.

In one embodiment, multiple graphical objects can be selected and dragged as a group to a data source window. In response, a combined search is created based upon the searches corresponding to the selected graphical objects. The individual searches are combined using logical operators, such as logical “AND” and “OR” operators. The combined preview search is sent to the data source and the preview results received are based on the combined preview search request.

In another embodiment, after the preview results are displayed to the user, the user can request full results using the same search request. For example, when preview results are displayed on the client computer system, the user can select a preview results window and, in response, a full search request is sent to the data source provider. In one embodiment, the data source provider retrieves information from a different data source when a full request is made as opposed to a preview request.

Finally, in one embodiment, if a preview request is invalid for a particular data source, an error message is displayed. In this manner, a user can refrain from requesting invalid full searches from a data source.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a system diagram showing preview results being received from a variety of data sources;

FIG. 2 shows screen diagrams of a drag and drop interface being used by a user to receive preview search results;

FIG. 3 shows screen diagrams of the drag and drop interface being used to perform parallel preview searches using multiple data sources;

FIG. 4 shows screen diagrams of the drag and drop interface being used to perform parallel preview searches using multiple data sources with an invalid search identified for one of the data sources;

FIG. 5 shows screen diagrams of the drag and drop interface being used to perform a combined preview search by dragging multiple search icons to a data source window;

FIG. 6 is a flowchart showing the steps taken in processing the user's search preview request;

FIG. 7 is a flowchart showing the steps taken in providing a preview of the requested search;

FIG. 8 is a flowchart showing the steps taken in combining searches using logical operators; and

FIG. 9 is a block diagram of an information processing system capable of performing the computations contemplated in the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

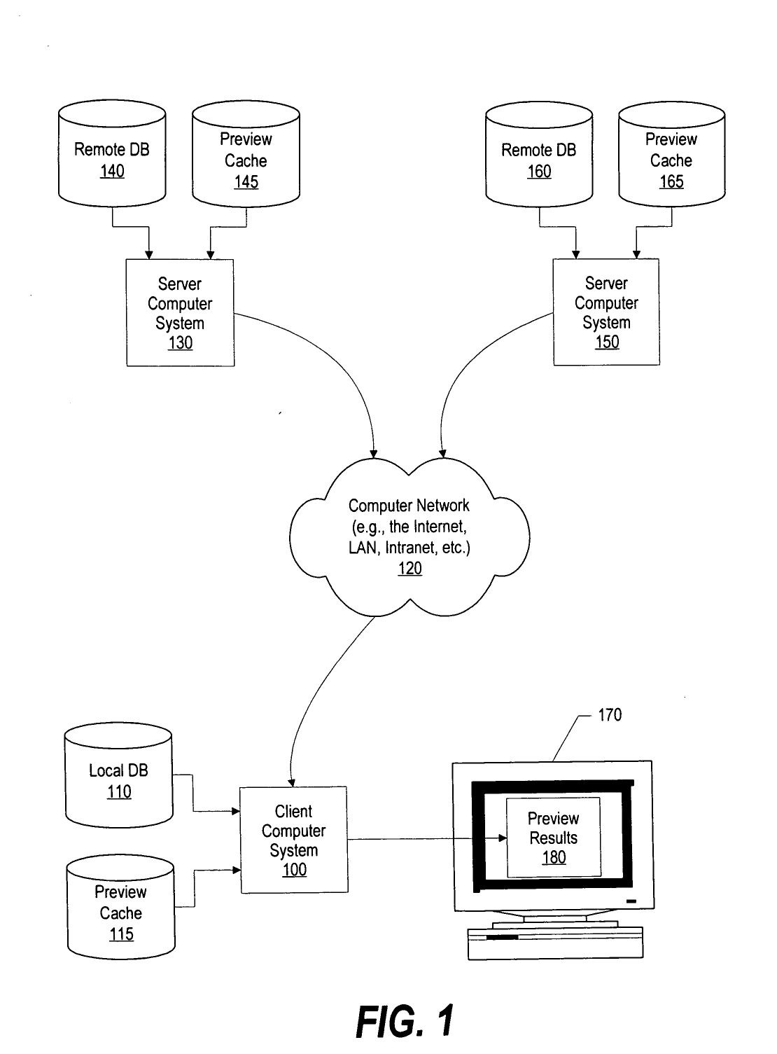

FIG. 1 is a system diagram showing preview results being received from a variety of data sources. In the example shown, client computer system 100 uses a variety of data sources. Local database 110 is a local database. Associated with local database 110 is preview cache 115 that includes data that is used for preview searches of the local data store. In addition, client computer system 100 is connected to computer network 120, such as the Internet, in order to connect to other data sources. In the example, two remote data sources are shown—server computer 130 and server computer 150. Each of these servers provide data to clients. Server computer 130 provides data from remote database 140 and server computer 150 provides data from remote database 160. In addition, each server computer has a cache that is used to provide responses to preview search requests that the servers receive from clients. Server computer 130 uses preview cache 145 that is associated with remote database 140, and server 150 uses preview cache 165 that is associated with remote database 160.

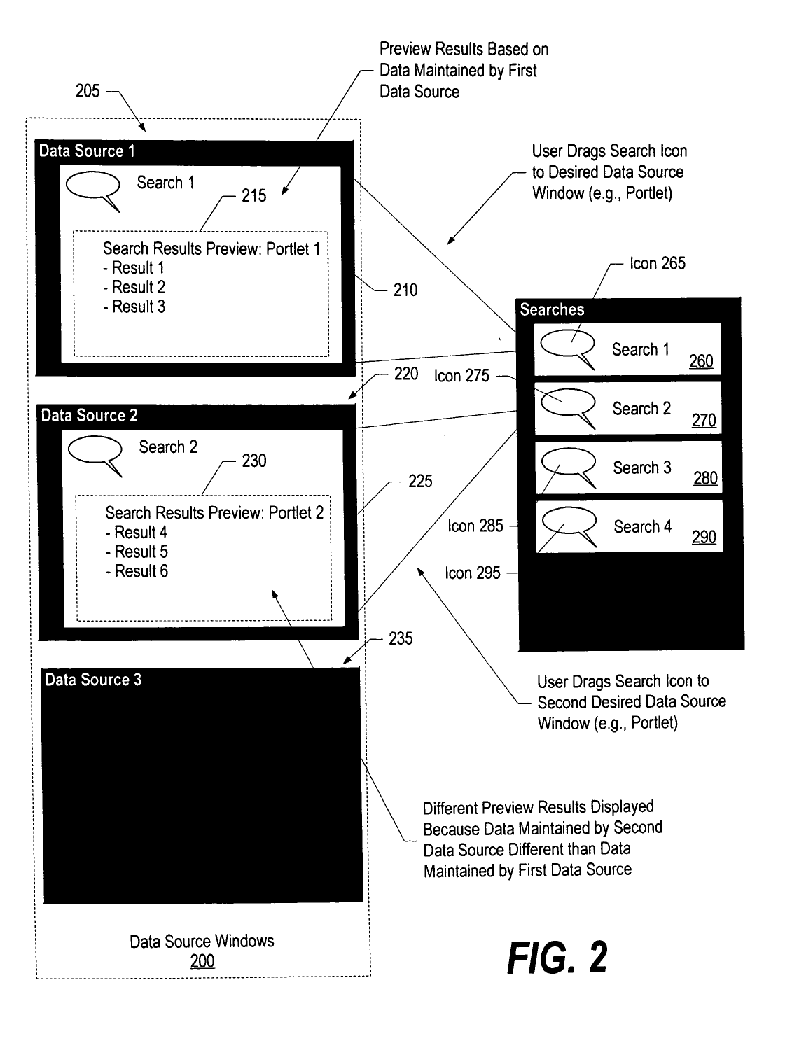

When client computer system 100 requests a preview search request from any of the data sources (local database 110, or remote databases managed by servers 130 and 150), the results from the preview request are returned to the client computer system and displayed as preview results 180 on display device 170, such as a monitor connected to client computer system 100. In forming the preview request, a drag and drop interface is provided. Various aspects of this interface are depicted in FIGS. 2-5 which are described below.

FIG. 2 shows screen diagrams of a drag and drop interface being used by a user to receive preview search results. Data source windows 200 are shown from which preview requests can be made. Each of these data source windows corresponds to a different data source. For example data source 1 (205) might correspond to the data source served by server computer 130 shown in FIG. 1, data source 2 (220) might correspond to the data source served by server computer 150 shown in FIG. 1, and data source 3 (235) might correspond to the data source served by local computer 100 shown in FIG. 1. As used herein, a “data source window” includes any data source representation, such as a container, window, GUI object, or the like.

In order to send a preview request to one of the data sources, the user selects a graphical object (265, 275, 285, or 295), such as an icon, from palate 250 of graphical objects. Each of the graphical objects corresponds to a different underlying database search. In the example shown, graphical object 265 corresponds to database search 260, graphical object 275 corresponds to database search 270, graphical object 285 corresponds to database search 280, and graphical object 295 corresponds to database search 290. The database searches can be formed using standard structured query language (SQL) syntax or can be formed using other syntax used by a particular database. As SQL is common throughout many different databases, an advantage to searches written in SQL is that they can be executed by a wide variety of databases.

The user drags a graphical object (icon) corresponding to a desired search from palate 250 to a desired data source. In the example shown, the user has dragged graphical object 265 from palate 250 to data source 1 (205) and has dragged graphical object 275 to data source 2 (220). This dragging action causes the underlying preview search requests, 260 and 270, to be sent to the data sources corresponding to data source window 205 and 220, respectively. The data source processes the preview search request by searching data stored in a preview data store, such as a cache, which is separate from the actual database. The preview results are designed to give the user a “feel” of the data that would be returned from the data source without actually running a full database search against the data source's database. This allows representative data to be quickly returned to the client without adding contention to the data source's database.

In the example shown in FIG. 2, results panels 210 and 225 are displayed for data source 1 (205) and data source 2 (220), respectively. The results panels display the search that was requested. The search that was requested can be a name supplied when the search requests were created or added to palate 250 or can include the actual search syntax (e.g., SQL statements) used in the search. In addition, the search panels each include search results preview 215 and 230, respectively. The search results preview include the preview results returned from the data sources in response to the preview search requests. In one embodiment, if the preview displayed in the preview results panel shows results of interest to the user, the user can request a full database search from the data source. The full search request can be accomplished using various user interface techniques, such as the user selecting the results panel (i.e., by clicking in the results panel using a pointing device). For example, if the preview provided by data source 1 are more desirable than those from data source 2, then the user can select results panel 210 and decide to not select results panel 225.

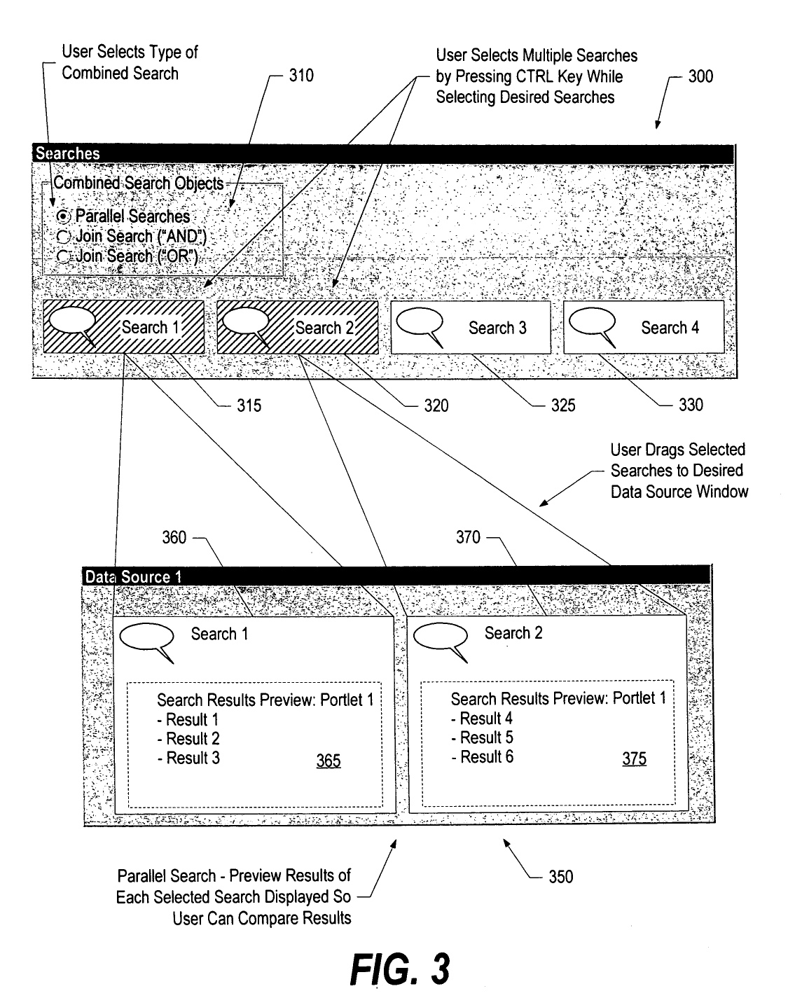

FIG. 3 shows screen diagrams of the drag and drop interface being used to perform parallel preview searches using multiple data sources. Window 300 includes a palate of various searches (search 1 (315), search 2 (320), search 3 (325), and search 4 (330), as well as combined search selection 310. Combined search selection 310 includes a radio button control that the user uses to select the type of combined search the user wants to perform. In the example shown, the combined search options include “parallel searches,” and two types of “join searches.” When the parallel search option is selected and two or more searches are dragged to a data source window then both searches are requested and displayed separately. As the name implies, in a “join search” two or more searches are combined using a logical operator, such as a logical “AND” and a logical “OR.” For example, if search 1 (315) selected all employees that were managers and search 2 (320) selected all employees that work in the state of “North Carolina” then combining the searches with an “AND” operator would yield all employees that are managers and live in the state of North Carolina. Likewise, an “OR” operator would yield all employees that are either managers (no matter where they work) as well as all employees in the state of North Carolina.

In the example shown in FIG. 3, a “parallel” search is requested with graphical objects 315 and 320 corresponding to searches 1 and 2, respectively, being selected and dragged to data source window 350 which corresponds to data source 1. This results in two result panels being displayed in data source window 350—results panel 360 (corresponding to search 1 (315)), and results panel 370 (corresponding to search 2 (320). Preview results returned by the data source corresponding to the two searches are displayed in search results preview panels 365 and 375. Using the example from FIG. 2, if Search 1 is a search request for all managers and Search 2 is a search request for all employees in North Carolina, then panel 365 would include preview results showing various managers and panel 375 would include preview results showing various employees in North Carolina. As preview searches, the results would likely show neither every manager nor every employee in North Carolina. Instead, a sampling of such data would be provided in response to the preview requests. In one embodiment, if the preview displayed in the preview results panel shows results of interest to the user, the user can request a full database search from the data source. The full search request can be accomplished using various user interface techniques, such as the user selecting the results panel (i.e., by clicking in the results panel using a pointing device).

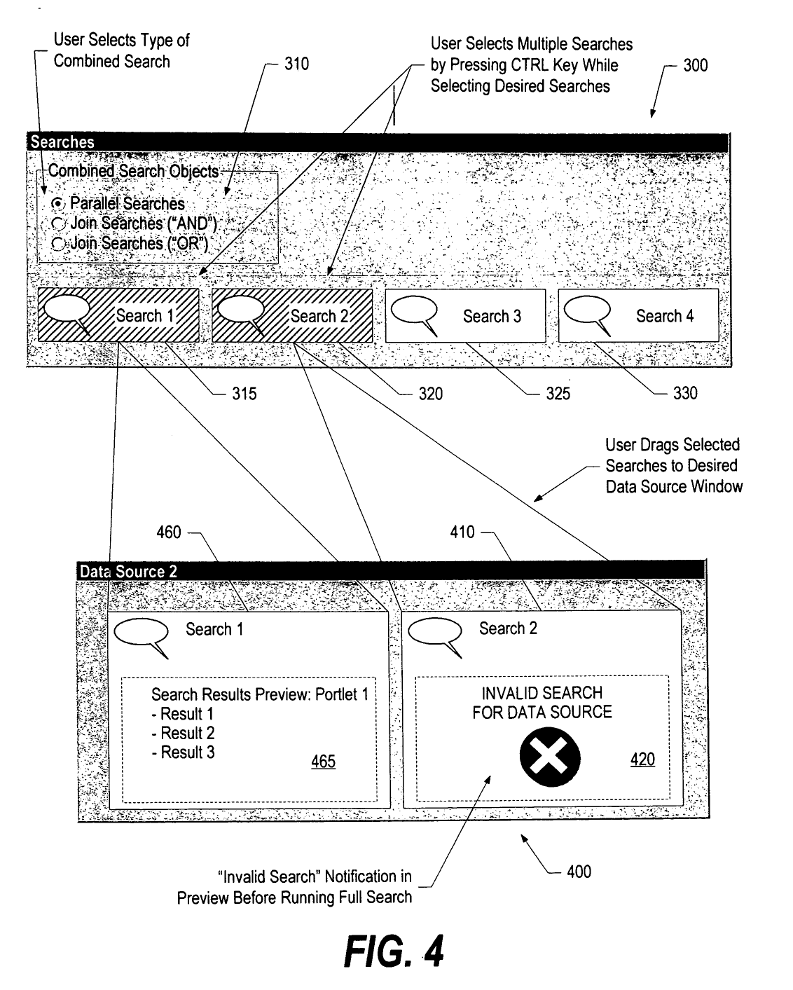

FIG. 4 shows screen diagrams of the drag and drop interface being used to perform parallel preview searches using multiple data sources with an invalid search identified for one of the data sources. FIG. 4 shows the same scenario outlined in FIG. 3. However, in FIG. 4 the searches are being requested from a different data source (data source 2 which corresponds to data source window 400). Using the example from FIGS. 2 and 3 with Search 1 (315) being a search for all “managers,” and Search 2 (320) being a search for all employees in “North Carolina,” provides different results in FIG. 4 than in FIG. 3. First, preview results 465 displayed in results panel 460 displays preview results from Search 1 (315) as such results pertain to data source 2 which might be quite different from the preview results that pertain to data source 1 that was shown in FIG. 3. Moreover, in. FIG. 4, the second search is invalid as it pertains to data source 2. This data source might not maintain location data that pertains to employees a search requesting all employees in a particular state is invalid. Error message 420 is returned and displayed in results panel 410 informing the user that the request is invalid. In this manner, the user can test out searches using preview requests and make sure that the search is valid before requesting a full database request from a particular data source. In one embodiment, if the preview displayed in the preview results panel shows results of interest to the user, the user can request a full database search from the data source. The full search request can be accomplished using various user interface techniques, such as the user selecting the results panel (i.e., by clicking in the results panel using a pointing device).

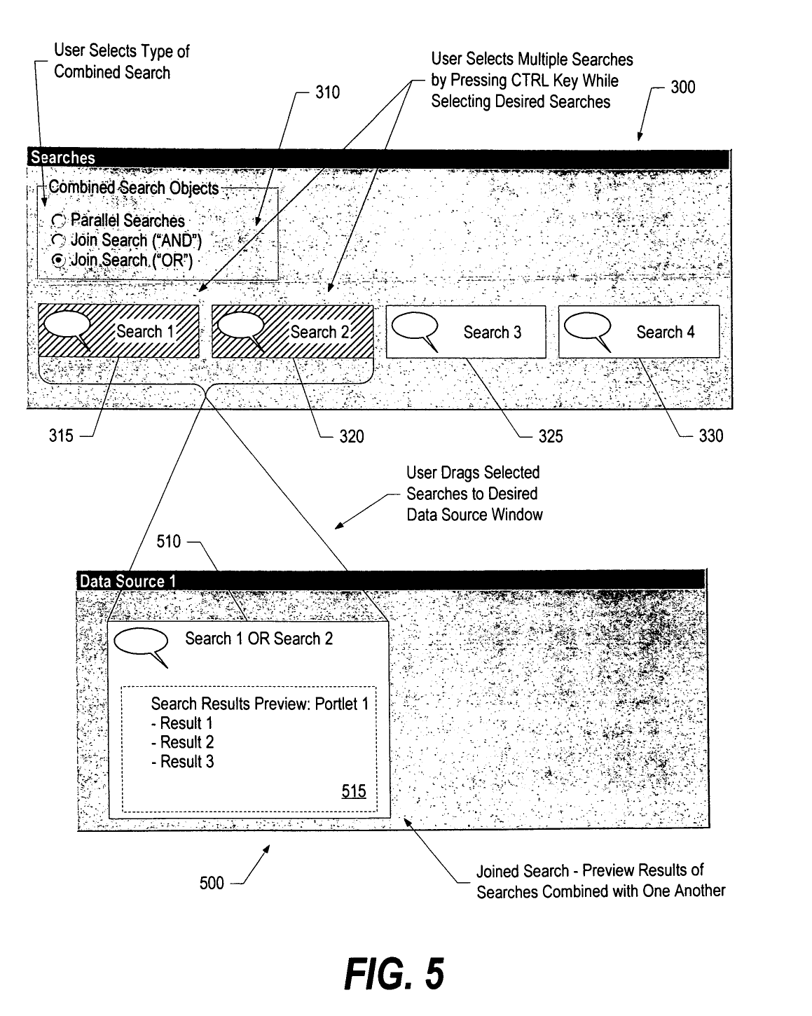

FIG. 5 shows screen diagrams of the drag and drop interface being used to perform a combined preview search by dragging multiple search icons to a data source window. In this example, the user has selected a “join search” from combined search selection 310. In particular, the user has selected a logical “OR” combination. The user selects two or more searches by selecting the desired searches using a combination key. For example, the user can hold down a key, such as the “control” key while clicking (using a mouse or other pointing device) on the desired searches. In FIG. 5, the user has selected two searches (315 and 320) that have been highlighted. The user then drags the group of selected searches to the desired data source window. In this case, the user has selected data source window 500 that corresponds to data source 1.

In response to dragging the combined search to data source window 500, result panel 510 is displayed in data source window 500. Result panel 510 indicates that two searches have been combined with a logical “OR” operation. The combined preview search request is sent to the data source and the data source responds by returning preview search results to the client. The preview search results are displayed in preview search results panel 515 within results panel 510. Using the example described in preceding Figures, if search 1 (315) selected all employees that were managers and search 2 (320) selected all employees that work in the state of “North Carolina” then combining the searches with an “OR” operator would yield all employees that are either managers (no matter where they work) as well as all employees in the state of North Carolina. A preview of these results would be displayed in preview results panel 515. In one embodiment, if the preview displayed in the preview results panel shows results of interest to the user, the user can request a full database search from the data source. The full search request can be accomplished using various user interface techniques, such as the user selecting the results panel (i.e., by clicking in the results panel using a pointing device).

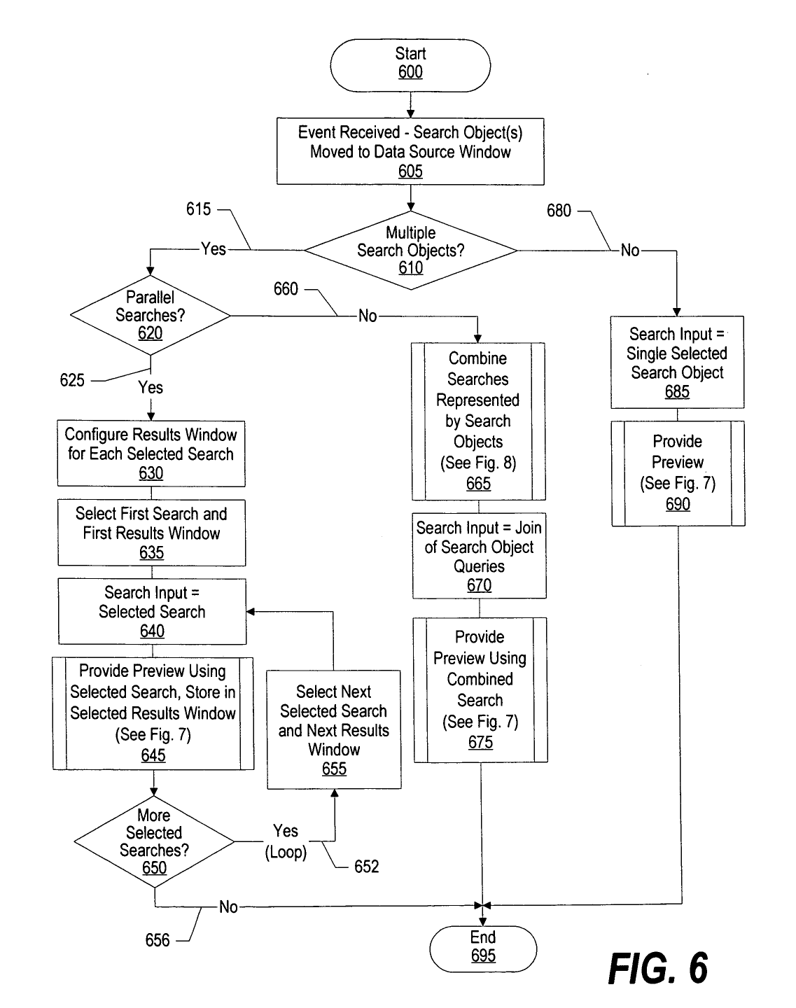

FIG. 6 is a flowchart showing the steps taken in processing the user's search preview request. Processing commences at 600 whereupon, at step 605, an event is received indicating that one or more search objects (icons) have been moved to a data source window. A determination is made as to whether the user has selected multiple search objects (decision 610). If multiple search objects have been selected, decision 610 branches to “yes” branch 615 whereupon another determination is made as to whether the user has requested parallel searches or a combination search.

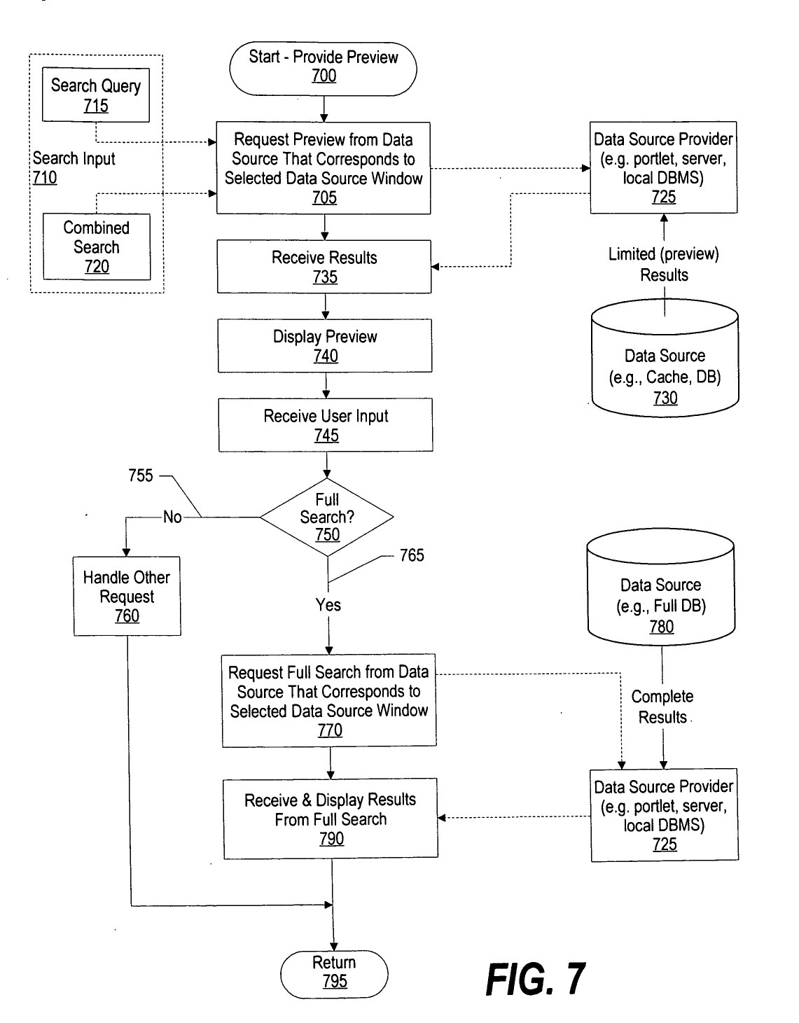

If the user has requested parallel searches, decision 625 branches to “yes” branch 625 whereupon a results window (panel) is configured to store results from each of the selected searches (step 630). At step 635, the first search and the first results window are selected. The search input for the results window is assigned to the selected search at step 640. A database search preview is performed and displayed in the selected search window (predefined process 645, see FIG. 7 and corresponding text for processing details). A determination is made as to whether there are more selected searches (decision 650). If there are more selected searches, decision 650 branches to “yes” branch 652 which selects the next search and the next results window (step 655) and loops back to process the next search selection and results window. This looping continues until all of the user's selections have been processed, at which time decision 650 branches to “no” branch 656 whereupon processing ends at 695.

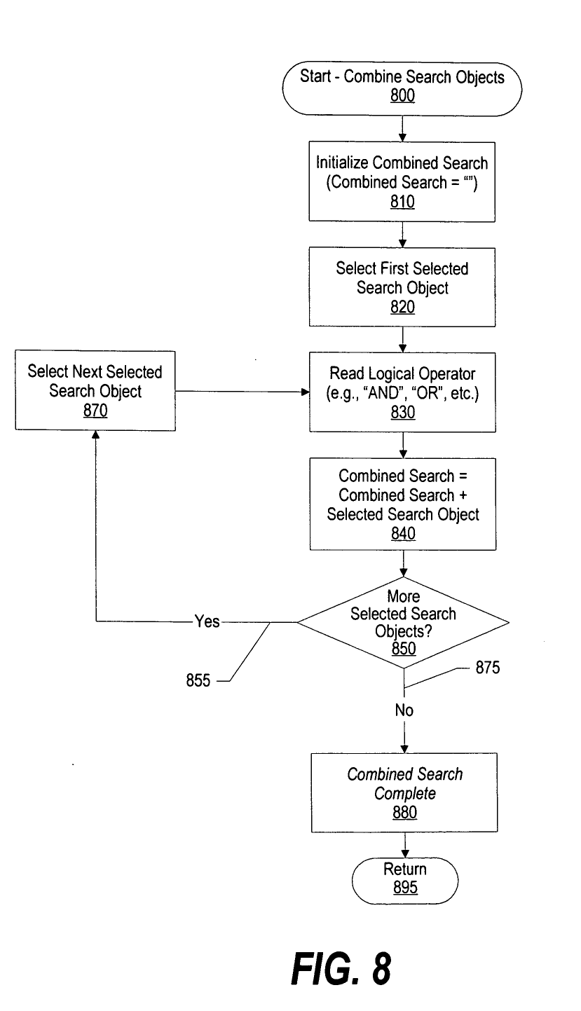

Returning to decision 620, if the user has requested a combination search, such as a logical “AND” or a logical “OR” search, decision 620 branches to “no” branch 660. The searches that correspond to the selected search objects (icons) are combined creating a combined search (predefined process 665, see FIG. 8 and corresponding text for processing details). At step 670, the search input (the query request sent to the data provider) is formed from the combined search. The preview of the search request is then provided to the user (predefined process 675, see FIG. 7 and corresponding text for processing details). Processing then ends at 695.

Finally, returning to decision 610, if the user did not request a multiple object search, decision 610 branches to “no” branch 680 whereupon, at step 680, the search is formed using the search corresponding to the selected search object (icon). The preview of the preview search request is then provided to the user (predefined process 690, see FIG. 7 and corresponding text for processing details). Processing then ends at 695.

FIG. 7 is a flowchart showing the steps taken in providing a preview of the preview search request. Processing commences at 700 whereupon, at step 705, a preview is requested from the data source corresponding to the data source window selected by the user. The search input (710) used in the request sent to the data provider can be either a single search query (715) or a combined search (720) that represents a combination two or more searches corresponding to search objects (icons) selected by the user. The preview request is sent to data source provider 725. The data source provider can be a portlet accessed over a network, such as the Internet, a server accessed over the network, or a local database management system (DBMS). The data source retrieves preview results from data source 730. The data source can be a cache that stores a limited representation of data that is stored in the full database. In addition, the data source can be the full database with restrictions applied to retrieve limited, or preview, results. For example, if a cache is not used, a number of preview records can be retrieved by performing the search against the full database for a limited amount of time with the records retrieved during the limited amount of time representing a preview search. The preview results are returned by the data source provider where they are received by the client at step 735. At step 740, the received preview results are displayed on the user's display device (i.e., in a results preview window or panel). At step 745, input regarding the displayed preview request is received. A determination is made as to whether the user has requested a full search based upon the search preview (decision 750). If the user has not requested a full search, decision 750 branches to “no” branch 755 whereupon, at step 760, the request is handled.

On the other hand, if the request is for a full search based upon the displayed preview results, decision 750 branches to “yes” branch 765 whereupon, at step 770, a request is made of the data source provider of a full search using the search criteria included in the search input. Data source provider 725 receives the request and retrieves complete results from data source 780. In this case, the data source is the full database. The full results are then returned to the client where they are received and displayed by the client at step 790. Processing thereafter returns to the calling routine at 795.

FIG. 8 is a flowchart showing the steps taken in combining searches using logical operators. Processing commences at 800 whereupon, at step 810, the combined search is initialized, such as by declaring a variable and setting it to an empty string. At step 820, the first search object that was selected by the user is selected. At step 830, a logical operator is read, such as a logical “AND” or a logical “OR.” The combined search string is built using the selected search object and the logical operator. A determination is made as to whether there are more selected search objects (decision 850). As a combined search string needs at least two search objects, decision 850 will be true (yes) at least once. If there are more selected search objects, decision 850 branches to “yes” branch 855 whereupon, at step 870, the next search object selected by the user is selected and processing loops back to include the selected search object in the combined search. This looping continues until all selected search objects have been combined, at which point decision 850 branches to “no” branch 875 and, at step 880, the combined search is complete. Processing thereafter ends at 895.

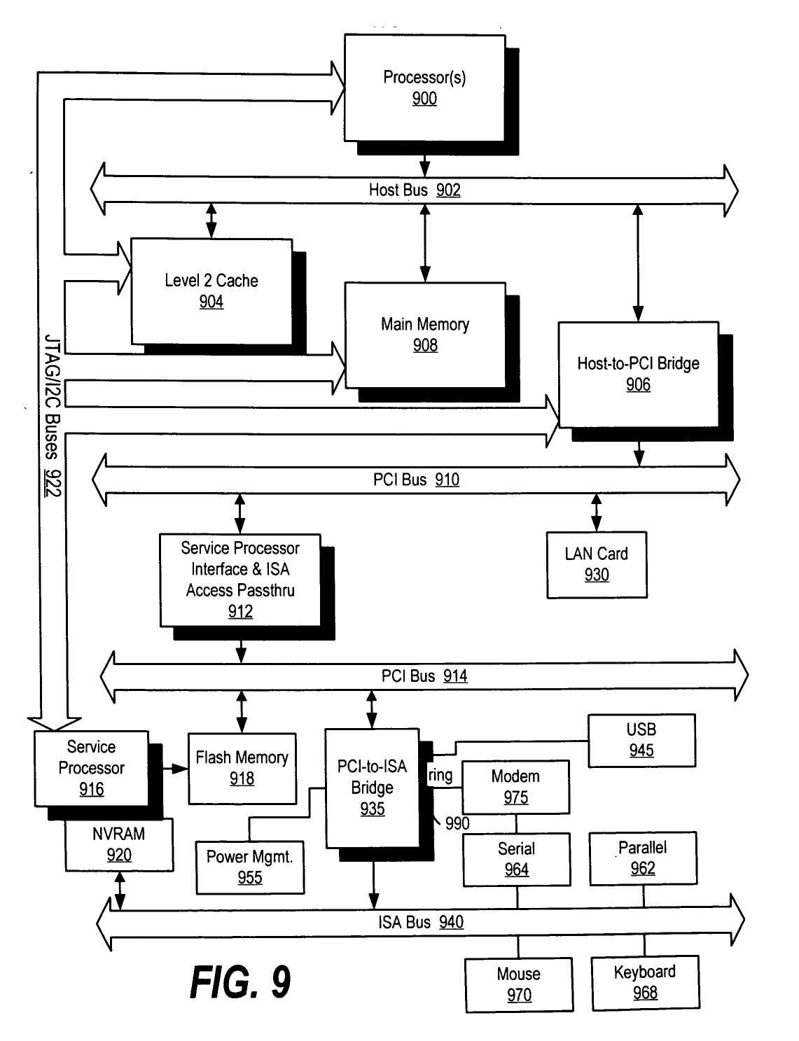

FIG. 9 illustrates information handling system 901 which is a simplified example of a computer system capable of performing the computing operations described herein. Computer system 901 includes processor 900 which is coupled to host bus 902. A level two (L2) cache memory 904 is also coupled to host bus 902. Host-to-PCI bridge 906 is coupled to main memory 908, includes cache memory and main memory control functions, and provides bus control to handle transfers among PCI bus 910, processor 900, L2 cache 904, main memory 908, and host bus 902. Main memory 908 is coupled to Host-to-PCI bridge 906 as well as host bus 902. Devices used solely by host processor(s) 900, such as LAN card 930, are coupled to PCI bus 910. Service Processor Interface and ISA Access Pass-through 912 provide an interface between PCI bus 910 and PCI bus 914. In this manner, PCI bus 914 is insulated from PCI bus 910. Devices, such as flash memory 918, are coupled to PCI bus 914. In one implementation, flash memory 918 includes BIOS code that incorporates the necessary processor executable code for a variety of low-level system functions and system boot functions.

PCI bus 914 provides an interface for a variety of devices that are shared by host processor(s) 900 and Service Processor 916 including, for example, flash memory 918. PCI-to-ISA bridge 935 provides bus control to handle transfers between PCI bus 914 and ISA bus 940, universal serial bus (USB) functionality 945, power management functionality 955, and can include other functional elements not shown, such as a real-time clock (RTC), DMA control, interrupt support, and system management bus support. Nonvolatile RAM 920 is attached to ISA Bus 940. Service Processor 916 includes JTAG and I2C busses 922 for communication with processor(s) 900 during initialization steps. JTAG/I2C busses 922 are also coupled to L2 cache 904, Host-to-PCI bridge 906, and main memory 908 providing a communications path between the processor, the Service Processor, the L2 cache, the Host-to-PCI bridge, and the main memory. Service Processor 916 also has access to system power resources for powering down information handling device 901.

Peripheral devices and input/output (I/O) devices can be attached to various interfaces (e.g., parallel interface 962, serial interface 964, keyboard interface 968, and mouse interface 970 coupled to ISA bus 940. Alternatively, many I/O devices can be accommodated by a super I/O controller (not shown) attached to ISA bus 940.

In order to attach computer system 901 to another computer system to copy files over a network, LAN card 930 is coupled to PCI bus 910. Similarly, to connect computer system 901 to an ISP to connect to the Internet using a telephone line connection, modem 975 is connected to serial port 964 and PCI-to-ISA Bridge 935.

While the computer system described in FIG. 9 is capable of executing the invention described herein, this computer system is simply one example of a computer system. Those skilled in the art will appreciate that many other computer system designs are capable of performing the invention described herein.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
selecting one or more graphical objects from a palate of graphical objects displayed on a display device, wherein each of the graphical objects corresponds to a different database search;
dragging the selected graphical search objects to a data source window displayed on the display device;
creating a preview request based upon the database searches that correspond to the selected graphical search objects;
sending the created preview request to a data source that corresponds to the data source window; and
receiving, from the data source, a results preview corresponding to the preview request, wherein the results preview includes fewer results than the data source would provide in response to a full search request using the same database searches.

2. The method of claim 1 further comprising:
retrieving, at the data source, the preview results from a cache that is separate from a database maintained by the data source.

3. The method of claim 1 further comprising:
selecting the data source window from a plurality of data source windows displayed on the display device by dragging the selected graphical search objects to the selected data source window;
selecting a second data source window from the plurality of data source windows by dragging the selected graphical search objects to the second data source window;
sending the created preview request to a second data source that corresponds to the second data source window; and
receiving, from the second data source, a second results preview corresponding to the preview request, wherein the second results preview includes fewer results than the second data source would provide in response to a full search request using the same database searches; and
displaying the results preview and the second results preview on the display device.

4. The method of claim 1 further comprising:
combining a plurality of the different database searches in response to the selection of two or more graphical objects resulting in a combined search; and
creating the preview request based upon the combined search.

5. The method of claim 4 wherein the combining further comprises:
retrieving at least one logical operator used to combine the searches, wherein the logical operator is selected from the group consisting of a logical AND, a logical OR, a logical NOT, and a logical XOR.

6. The method of claim 1 further comprising:
displaying the preview results on the display device;
sending to the data source a full database search request in response to the displayed preview results;
receiving, from the data source, a full results corresponding to the full database search request, wherein the full results includes more results than the results preview; and
displaying the full results on the display device.

7. The method of claim 1 further comprising:
receiving, from the data source, an error message indicating that the database searches included in the preview request are invalid for the data source; and
displaying the error message on the display device.

8. An information handling system comprising:
one or more processors;
a display device accessible by the processors;
a memory accessible by the processors;
one or more user controlled input devices;
a network adapter that connects the information handling device to a computer network; and
a process operated by the processors that is effective to:
select, using one of the input devices, one or more graphical objects from a palate of graphical objects displayed on the display device, wherein each of the graphical objects corresponds to a different database search;
drag, using one of the input devices, the selected graphical search objects to a data source window displayed on the display device;
create a preview request based upon the database searches that correspond to the selected graphical search objects;
send, using the network adapter, the created preview request to a data source that corresponds to the data source window; and
receive, using the network adapter, a results preview corresponding to the preview request from the data source, wherein the results preview includes fewer results than the data source would provide in response to a full search request using the same database searches.

9. The information handling system of claim 8 wherein the process is further effective to:
retrieving, at the data source, the preview results from a cache that is separate from a database maintained by the data source.

10. The information handling system of claim 8 wherein the process is further effective to:
selecting the data source window from a plurality of data source windows displayed on the display device by dragging the selected graphical search objects to the selected data source window;
selecting a second data source window from the plurality of data source windows by dragging the selected graphical search objects to the second data source window;
sending the created preview request to a second data source that corresponds to the second data source window; and
receiving, from the second data source, a second results preview corresponding to the preview request, wherein the second results preview includes fewer results than the second data source would provide in response to a full search request using the same database searches; and
displaying the results preview and the second results preview on the display device.

11. The information handling system of claim 8 wherein the process is further effective to:
combining a plurality of the different database searches in response to the selection of two or more graphical objects resulting in a combined search; and
creating the preview request based upon the combined search.

12. The information handling system of claim 11 wherein the process is further effective to:
retrieving at least one logical operator used to combine the searches, wherein the logical operator is selected from the group consisting of a logical AND, a logical OR, a logical NOT, and a logical XOR.

13. The information handling system of claim 8 wherein the process is further effective to:
displaying the preview results on the display device;
sending to the data source a full database search request in response to the displayed preview results;
receiving, from the data source, a full results corresponding to the full database search request, wherein the full results includes more results than the results preview; and
displaying the full results on the display device.

14. The information handling system of claim 8 wherein the process is further effective to:
receiving, from the data source, an error message indicating that the database searches included in the preview request are invalid for the data source; and
displaying the error message on the display device.

15. A program product comprising:
a computer operable medium having computer readable code, the computer readable code being effective to:
select one or more graphical objects from a palate of graphical objects displayed on a display device, wherein each of the graphical objects corresponds to a different database search;
drag the selected graphical search objects to a data source window displayed on the display device;
create a preview request based upon the database searches that correspond to the selected graphical search objects;
send the created preview request to a data source that corresponds to the data source window; and
receive, from the data source, a results preview corresponding to the preview request, wherein the results preview includes fewer results than the data source would provide in response to a full search request using the same database searches.

16. The program product of claim 15 wherein the computer readable code is further effective to:
retrieve, at the data source, the preview results from a cache that is separate from a database maintained by the data source.

17. The program product of claim 15 wherein the computer readable code is further effective to:
select the data source window from a plurality of data source windows displayed on the display device by dragging the selected graphical search objects to the selected data source window;
select a second data source window from the plurality of data source windows by dragging the selected graphical search objects to the second data source window;
send the created preview request to a second data source that corresponds to the second data source window; and
receive, from the second data source, a second results preview corresponding to the preview request, wherein the second results preview includes fewer results than the second data source would provide in response to a full search request using the same database searches; and
display the results preview and the second results preview on the display device.

18. The program product of claim 15 wherein the computer readable code is further effective to:
combine a plurality of the different database searches in response to the selection of two or more graphical objects resulting in a combined search; and
create the preview request based upon the combined search.

19. The program product of claim 15 wherein the computer readable code is further effective to:
retrieve at least one logical operator used to combine the searches, wherein the logical operator is selected from the group consisting of a logical AND, a logical OR, a logical NOT, and a logical XOR.

20. The program product of claim 15 wherein the computer readable code is further effective to:
display the preview results on the display device;
send to the data source a full database search request in response to the displayed preview results;
receive, from the data source, a full results corresponding to the full database search request, wherein the full results includes more results than the results preview; and
display the full results on the display device.
